(19) United States
(12) Patent Application Publication
(10) Pub. No.: US 2007/0003045 A1
(43) Pub. Date: Jan. 4, 2007

(54) Off hold notification in communication networks

(75) Inventors: Cynthia K. Florkey, Chicago, IL (US); Ruth S. Gayde, Naperville, IL (US); John R. Rosenberg, Elmhurst, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/167,982

(22) Filed: Jun. 27, 2005

(51) Int. Cl. H04M 3/42

(52) U.S. Cl. 379/215.01; 379/211.01

(57) ABSTRACT

Communication networks and methods are disclosed that notify a party when a call has been taken off hold. Over a communication network, a first party places a first call to a second party. At some point during the first call, the second party has put the first call on hold. When the first call has been put on hold, the first party establishes a second call over the communication network with a third party. The second party then takes the first call off hold. According to the invention, a hold determination system in the communication network determines that the first call has been taken off hold. A notification system then notifies the first party that the second party has taken the first call off hold. The notification system may also notify the second party that the first party will return to the first call momentarily.

### BACKGROUND OF THE INVENTION

1. Field of the Invention

The invention is related to the field of communication networks and, in particular, to off hold notification in communication networks. More particularly, when a party on hold leaves a first call to place or receive a second call, the communication network of the invention notifies the party when the first call has been taken off hold.

2. Statement of the Problem

Current communication devices have the ability to allow phone users to be on more than one call at a time. One example is call waiting. With call waiting, a phone user on one call may receive another call, and the network notifies the phone user of the other call with a series of tones. The phone user may then switch over to the other call (e.g., a flash function) while the original call is on hold using his/her multi-function phone. The phone user can switch between the calls depending on which one he/she wishes to continue.

Another example is a multi-line phone. With a multi-line phone, the phone user subscribes to two or more lines. The phone user may have multiple calls active on the lines, and use the phone to switch between the lines to place or receive different calls.

The ability to have more than one call active at one time is hindered if the other party of a call puts the phone user on hold. As an example of the problem, assume a caller places a call to a large business utilizing a call center. The call center answers the call, but all agents at the call center are currently busy on other calls. The call center will then put the caller on hold until an agent is available. Depending on the size of the business and the time of the call, this hold time for the agent may be five minutes, ten minutes, thirty minutes, or more. During this time when the caller is on hold, the caller may want to place or receive another call using his/her multi-function phone. If the caller does make another call, the caller will have to leave the original call to do so. Assume the agent in the call center becomes available while the caller is on the other call. The agent will try to converse with the caller, but will hear no response on the other end. Responsive to hearing silence at the other end, the agent may hang up assuming that the caller hung up. The caller would then have to call the business again and restart the process.

Unfortunately, current communication networks do not notify the caller when the agent takes the original call off hold, which does not allow the caller to take advantage of the multiple-call functionality of the phones and the communication network.

### SUMMARY OF THE SOLUTION

The invention solves the above and other related problems by notifying a caller when a call has been taken off hold. If a caller on a first call is placed on hold and the caller places or receives a second call, the invention provides for notification of the caller when the first call has been taken off hold. Responsive to the notification, the caller may advantageously return to the first call and avoid having the other party hang up.

In one embodiment, a communication network of the invention includes a hold determination system and a notification system. Over the communication network, a first party places a first call to a second party. At some point during the first call, the second party puts the first call on hold. When the first call has been put on hold, the first party establishes a second call over the communication network with a third party. The second party then takes the first call off hold. According to the invention, the hold determination system in the communication network determines that the first call has been taken off hold. The notification system, responsive to the determination by the hold determination system, notifies the first party that the second party has taken the first call off hold. For instance, notification system may notify the first party by transmitting tones to the first party, by transmitting a voice message to the first party, or by transmitting a text message to the first party. The notification system may also notify the second party that the first party will return to the first call momentarily.

Responsive to the notification by the communication network, the first party may return to the first call. By notifying the first party that the first call has been taken off hold, the first party is advantageously allowed to place or receive the second call without risk of losing the first call when the second party takes the first call off hold.

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of operating the communication network of FIG. 1 in an exemplary embodiment of the invention.

FIG. 3 illustrates another embodiment of a communication network.

### DETAILED DESCRIPTION OF THE INVENTION

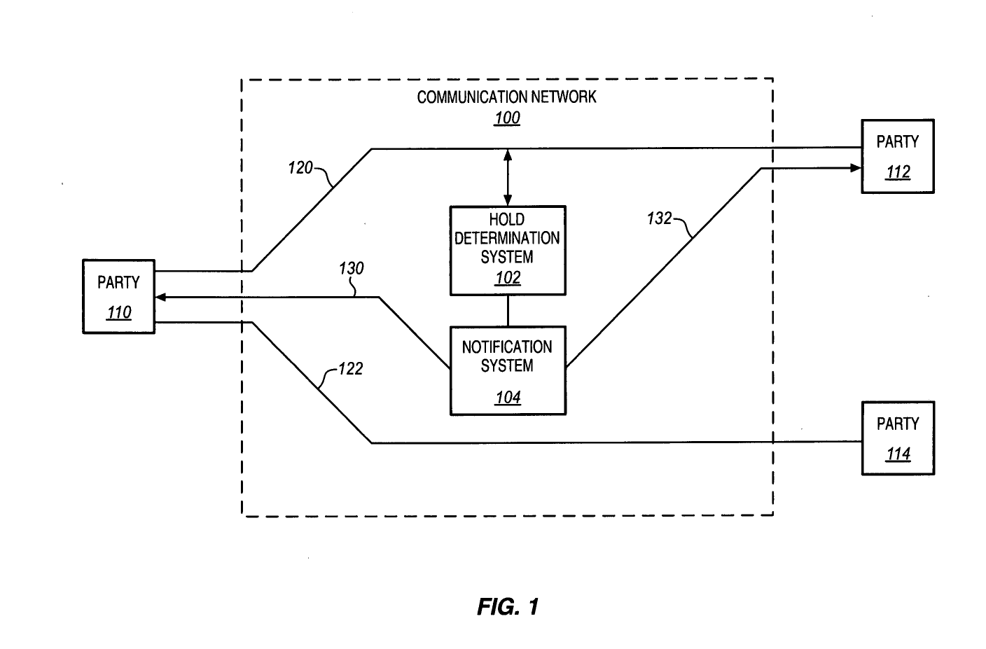

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a wireless network, a wireline network, a circuit-based network, a packet-based network, or any other network or combination thereof. Communication network 100 includes a hold determination system 102 and a notification system 104. Communication network 100 may include other networks, systems, or devices not shown in FIG. 1.

Communication network 100 is operable to connect a call between a first party 110 and a second party 112, and is operable to connect a call between first party 110 and a third party 114. Party 110 may be using a mobile phone or mobile station, a landline phone, VoIP phone, or some other communication device. Similarly, party 112 and party 114 may be using a mobile phone or mobile station, a landline phone, a VoIP phone, or some other communication device.

Hold determination system 102 and notification system 104 may be operating on the same platform in communication network 100, or may be remote from one another in communication network 100. For instance, one or both of hold determination system 102 and notification system 104 may run on an originating node (not shown) for communication network 100, such as an originating Mobile Switching Center (MSC) or an originating switch. One or both of hold determination system 102 and notification system 104 may run on a terminating node (not shown) for communication network 100, such as a terminating MSC or a terminating switch. One or both of hold determination system 102 and notification system 104 may run on an intelligent peripheral (not shown) or intelligent resource in communication network 100.

Hold determination system 102 and notification system 104 may be implemented in hardware, software, or a combination thereof. For instance, hold determination system 102 and notification system 104 may be comprised of instructions that are stored on storage media. The instructions may be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. The term “processor” refers to a single processing device or a group of inter-operational processing devices. Some examples of processors are computers, integrated circuits, and logic circuitry.

When in operation, assume that party 110 has placed a first call to party 112. Line 120 through communication network 100 illustrates the first call being connected between party 110 and party 112 over communication network 100. At some point during the first call, party 112 has put the first call on hold. Putting a call or a party on hold means that a call is connected but one party is not active on the call. When the first call has been put on hold, party 110 establishes a second call with party 114. Line 122 through communication network 100 illustrates the second call being connected between party 110 and party 114 over communication network 100.

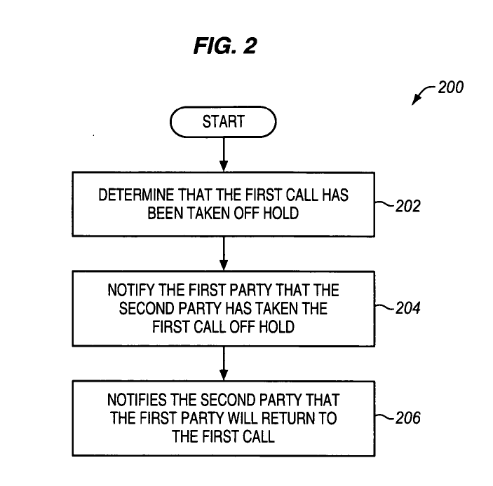

According to the invention, communication network 100 is operable to notify party 110 when the first call has been taken off hold by party 112 so that party 110 may return to the first call. FIG. 2 is a flow chart illustrating a method 200 of operating communication network 100 to notify party 110 when the first call has been taken off hold in an exemplary embodiment of the invention. The steps of the flow chart in FIG. 2 are not all inclusive and may include other steps not shown.

In step 202 of method 200, hold determination system 102 determines that the first call has been taken off hold. The double arrow in FIG. 1 illustrates that hold determination system 102 is able to access the signaling path or bearer path for the first call. Hold determination system 102 may make this determination according to many desired implementations. In one embodiment, hold determination system 102 receives signaling from a call control element (not shown) serving party 112, where the signaling indicates that the first call has been taken off hold. The signaling may be ISDN User Part (ISUP), Session Initiation Protocol (SIP), or some other signaling protocol. One example of such signaling is disclosed in the ITU-T specification Q.733. In another embodiment, hold determination system 102 may use automatic speech recognition logic to determine that party 112 has taken the first call off hold and begun speaking. The speech recognition logic is able to distinguish active voice from a recording or music typically used by call centers. Active voice is defined herein as speech from a person being a party to a call, as distinguished from recordings or music.

In step 204, notification system 104, responsive to the determination by hold determination system 102, notifies party 110 that party 112 has taken the first call off hold. Notification system 104 may notify party 110 according to many desired implementations. The notification to party 110 is shown generally in FIG. 1 as arrow 130. In one embodiment, notification system 104 may transmit tones to party 110 over the bearer path for the second call, similar to way networks handle call waiting. In another embodiment, notification system 104 may transmit a voice message to party 110 over the bearer path for the second call. In another embodiment, notification system 104 may transmit a text message to party 110 (assuming party 110 is properly equipped to receive text messages).

In step 206, notification system 104 notifies party 112 that party 110 will return to the first call momentarily. The notification to party 112 is shown generally in FIG. 1 as arrow 132. In one embodiment, notification system 104 may transmit a voice message to party 112 over the bearer path for the first call. In another embodiment, notification system 104 may transmit a text message to party 112 (assuming party 112 is properly equipped to receive text messages). This optional step is included to ensure that party 112 stays on the first call if it takes party 110 a few seconds to return to the first call.

Responsive to the notification by communication network 100, party 110 may return to the first call. By notifying party 110 that the first call has been taken off hold, party 110 is advantageously allowed to establish the second call without risk of losing the first call when party 112 takes the first call off hold.

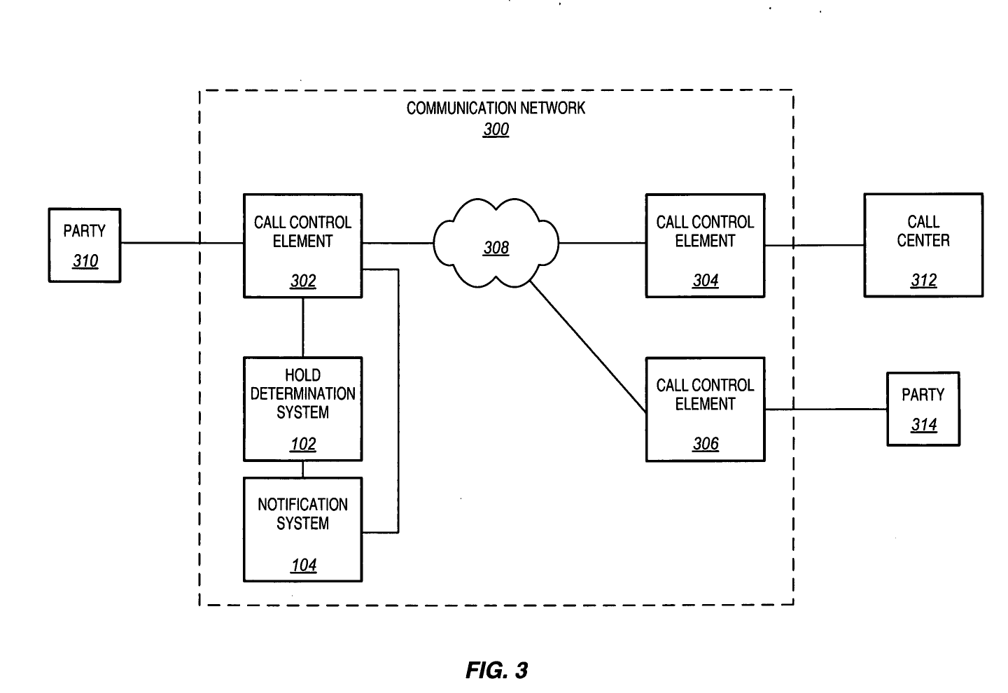

FIG. 3 illustrates another embodiment of a communication network 300 in an exemplary embodiment of the invention. Communication network 300 is operable to connect a call between a first party 310 and a call center 312, and is operable to connect a call between first party 310 and a second party 314. Communication network 300 includes call control elements 302, 304, and 306 connected by a network cloud 308. The network cloud 308 between the call control elements 302, 304, and 306 illustrates that they may be connected through any type of network, such as a circuit-based network, a packet-based network, etc. Call control element 302 handles call control functionality for party 310. Call control element 302 may be part of an MSC, a switch, or some other network node. Call control element 304 handles call control functionality for call center 312. Call control element 306 handles call control functionality for party 314. Communication network 300 may include other networks, systems, or devices not shown in FIG. 3.

In this embodiment, hold determination system 102 and notification system 104 are connected to call control element 302. As previously stated, hold determination system 102 and notification system 104 may be implemented in other desired location in communication network 300. For instance, one or both of hold determination system 102 and notification system 104 may be connected to call control element 304.

In this embodiment, party 310 is using a single line phone having multi-call functionality, such as through a flash function. When in operation, party 310 places a first call to call center 312 over communication network 300. Call center 312 is servicing a large business with a heavy call volume (e.g., an airline), so call center 312 puts the first call on hold. When on hold, party 310 establishes a second call with party 314 over communication network 300. During the second call, call center 312 takes the first call off hold and connects the first call through to an agent. The agent begins speaking, such as “May I help you?”.

According to the invention, hold determination system 102 determines that the first call has been taken off hold. Hold determination system 102 may receive signaling from call control element 304 indicating that the first call has been taken off hold. Hold determination system 102 may alternatively use automatic speech recognition logic to determine that the agent has taken the first call off hold and begun speaking.

Responsive to the determination by hold determination system 102, notification system 104 notifies party 310 through call control element 302 that call center 312 has taken the first call off hold. In this embodiment, assume that notification system 104 transmits tones to party 310 over the bearer path for the second call. Notification system 104 also notifies the agent in call center 312 that party 310 will return to the first call momentarily. For instance, notification system 104 may transmit a message such as “The calling party will be back momentarily”. The agent hears the message from notification system 104 and stays on the line. Party 310 hears the tones transmitted by notification system 104 and switches back to the first call. Party 310 then converses with the agent.

In another embodiment of FIG. 3, party 310 is using a multi-line phone. When in operation, party 310 places a first call to call center 312 over a first line of communication network 300. Call center 312 puts the first call on hold. When on hold, party 310 establishes a second call with party 314 over a second line of communication network 300. During the second call, call center 312 takes the first call off hold and connects the first call through to an agent. The agent then begins speaking.

According to the invention, hold determination system 102 determines when the first call on the first line has been taken off hold. Responsive to the determination by hold determination system 102, notification system 104 associates the first line for the first call with the second line for the second call. Notification system 104 may have a database having a profile established for party 310. Responsive to party 310 placing or receiving calls, notification system 104 updates the profile for party 310 so that notification system 104 is able to identify the lines over which party 310 has active calls established.

After notification system 104 associates the first line for the first call to the second line for the second call, notification system 104 notifies party 310 through call control element 302 over the second line for the second call that call center 312 has taken the first call off hold. In this embodiment, assume that notification system 104 transmits tones to party 310 over the second line. Notification system 104 also notifies the agent in call center 312 that party 310 will return to the first call momentarily. The agent hears the message from notification system 104 and stays on the line. Party 310 hears the tones transmitted by notification system 104 over the second line and switches from the second line back to the first line. Party 310 then converses with the agent.

Although specific embodiments were described herein, the scope of the invention is not limited to those specific embodiments. The scope of the invention is defmed by the following claims and any equivalents thereof.

We claim:

1. A communication network operable to connect a first call between a first party and a second party, where the second party has put the first call on hold and the first party has established a second call with a third party, the communication network comprising:
a hold determination system operable to determine that the second party has taken the first call off hold; and
a notification system responsive to the determination to notify the first party that the second party has taken the first call off hold.

2. The communication network of claim 1 wherein the notification system is operable to notify the second party that the first party will return to the first call.

3. The communication network of claim 1 wherein the hold determination system processes signaling received from a call control element serving the second party to determine that the second party has taken the first call off hold.

4. The communication network of claim 1 wherein the hold determination system detects active voice over the bearer path for the first call to determine that the second party has taken the first call off hold.

5. The communication network of claim 1 wherein the notification system is operable to transmit tones over the bearer path for the second call to notify the first party.

6. The communication network of claim 1 wherein the notification system is operable to transmit a voice message over the bearer path for the second call to notify the first party.

7. The communication network of claim 1 wherein the notification system is operable to transmit a text message to the first party to notify the first party.

8. The communication network of claim 1 wherein if the first party is using a multi-line phone, then the notification system is operable to associate the line for the first call with the line for the second call to notify the first party over the line for the second call.

9. A method of operating a communication network connecting a first call between a first party and a second party, where the second party has put the first call on hold and the first party has established a second call with a third party, the method comprising;
determining that the second party has taken the first call off hold; and
notifying the first party that the second party has taken the first call off hold.

10. The method of claim 9 further comprising:
notifying the second party that the first party will return to the first call.

11. The method of claim 9 wherein determining that the second party has taken the first call off hold comprises:
processing signaling received from a call control element serving the second party to determine that the second party has taken the first call off hold.

12. The method of claim 9 wherein determining that the second party has taken the first call off hold comprises:
detecting active voice over the bearer path for the first call to determine that the second party has taken the first call off hold.

13. The method of claim 9 wherein notifying the first party that the second party has taken the first call off hold comprises:
transmitting tones over the bearer path for the second call to notify the first party.

14. The method of claim 9 wherein notifying the first party that the second party has taken the first call off hold comprises:
transmitting a voice message over the bearer path for the second call to notify the first party.

15. The method of claim 9 wherein notifying the first party that the second party has taken the first call off hold comprises:
transmitting a text message to the first party to notify the first party.

16. The method of claim 9 wherein if the first party is using a multi-line phone, then the method further comprises:
associating the line for the first call with the line for the second call to notify the first party over the line for the second call.

17. A communication network, comprising:
a first call control element serving a first party;
a second call control serving a second party;
wherein the first call control element and the second call control element are operable to connect a first call between the first party and the second party, where the second party has put the first call on hold and the first party has established a second call with a third party;
a hold determination system operable to determine that the second party has taken the first call off hold; and
a notification system responsive to the determination to notify the first party that the second party has taken the first call off hold.

18. The communication network of claim 17 wherein the notification system is operable to notify the second party that the first party will return to the first call.

19. The communication network of claim 17 wherein the hold determination system detects active voice over the bearer path for the first call to determine that the second party has taken the first call off hold.

20. The communication network of claim 17 wherein the notification system is operable to transmit tones over the bearer path for the second call to notify the first party.
